(19) United States
(12) Patent Application Publication
(10) Pub. No.: US 2026/0071035 A1
(43) Pub. Date: Mar. 12, 2026

(54) Reinforced fiber thermoplastic prepreg, sports equipment body and forming method thereof

(71) Applicant: Dongguan Taihe Composite Materials Co., Ltd., Dongguan City (CN)

(72) Inventors: Jinsong Chen, Dongguan City (CN); Hua Wang, Dongguan City (CN); Jianqiang Zeng, Dongguan City (CN); Peng Li, Dongguan City (CN)

(73) Assignee: Dongguan Taihe Composite Materials Co., Ltd., Dongguan City (CN)

(21) Appl. No.: 18/829,922

(22) Filed: Sep. 10, 2024

(51) Int. Cl. C08J 5/24

(52) U.S. Cl. CPC C08J 5/24; C08J 2363/02

(57) ABSTRACT

The present invention provides a reinforced fiber thermoplastic prepreg. The reinforced fiber thermoplastic prepreg comprises reinforced fibers and a composite resin system, wherein the composite resin system comprises bisphenol glycidyl ether type epoxy resin, a dihydric phenol compound and a catalyst; the weight average molecular weight of the bisphenol glycidyl ether type epoxy resin is 300-1,000; the catalyst comprises at least one of a quaternary ammonium catalyst and an organic phosphine catalyst. The reinforced fiber thermoplastic prepreg has good tackiness and flexibility at normal temperature and can be flexibly suitable for preforming of various special-shaped products. The composite resin system can be polymerized in a situ polymerization manner on the surfaces of the reinforced fibers to produce thermoplastic resin capable of enhancing long-term and firm compounding of fibers.

### TECHNICAL FIELD

The present invention belongs to the technical field of sports equipment, and particularly relates to a reinforced fiber thermoplastic prepreg, sports equipment body and a molding method thereof.

### BACKGROUND

A reinforced fiber prepreg refers to an intermediate made of reinforced fibers impregnated with uncured resin. Currently, reinforced fiber prepregs are applied to various fields, for example, in the field of automotive products, the reinforced fiber prepregs can be applied to the production of interior decorative plates, seat supports, etc. In the field of sporting goods, reinforced fiber prepregs can be used for manufacturing high-performance sports equipment, such as bicycle frames and racing boats.

When thermosetting resin is used as the matrix resin for preparing reinforced fiber prepregs, reinforced fiber prepregs require toughening modification on the thermosetting resin. In addition, thermosetting resin also has the disadvantage of difficulty of recycling the reinforced fibers compounded with the thermosetting resin, and resulting in a waste of resources. Compared with thermosetting resin, thermoplastic resin has the advantages of good toughness and high easiness in recycling of reinforced fibers compounded with the thermoplastic resin. The current methods of manufacturing reinforced fiber prepregs by using thermoplastic resin as matrix resin are mainly a hot melt method or a solvent method: the hot melt method is mainly to melt thermoplastic resin into viscous liquid through a method of heating and then impregnate fibers. However, thermoplastic resin melts all have high melt tackiness, which brings certain difficulty to the impregnation and forming of reinforced fibers. In addition, thermoplastic resins generally are high in melting temperature, so that the thermoplastic resin needs to be kept in a melt state and a large amount of energy is consumed during the process of preparation and processing of reinforced fiber prepregs; the solvent method is to dissolve the thermoplastic resin into a solution through an appropriate solvent, then impregnate the reinforced fibers through the solution, and then remove the solvent in the solution. As the methods directly process (melt or dissolve) impregnated reinforced fibers through thermoplastic resin with high molecular weight, the resulting reinforced fiber prepreg generally is non-viscous, hard in texture and poor in forming effect, cannot be manufactured into a blank through manual lamination, and is difficult to produce special-shaped thermoplastic fiber reinforced composite products with complex models.

### SUMMARY

The purpose of the present invention is to provide a reinforced fiber thermoplastic prepreg. A prepreg has good tackiness (tacky, drop) at normal temperature and can be manually laminated to form a sports equipment preform; the sports equipment preform can then be polymerized in an in situ polymerization manner at high temperature and high pressure to form a sports equipment body, so that the reinforced fiber thermoplastic prepreg can be used to easily and flexibly form sports equipment bodies of various shapes and with good mechanical properties.

According to a first aspect of the present invention, a reinforced fiber thermoplastic prepreg is provided. The reinforced fiber thermoplastic prepreg comprises reinforced fibers and a composite resin system, wherein the composite resin system comprises bisphenol glycidyl ether type epoxy resin, a dihydric phenol compound, a catalyst and a polar solvent; the weight average molecular weight of the bisphenol glycidyl ether type epoxy resin is 300 to 1000; the catalyst comprises at least one of a quaternary ammonium catalyst and an organic phosphine catalyst. Based on the component compositions of the composite resin system, the composite resin system is low in reactivity in normal temperature conditions, cannot form polymer with high molecular weight, and can maintain relatively stable component compositions. Therefore, on the one hand, the composite resin system maintains the moderate tackiness, can adhere to the surfaces of the reinforced fibers, is not too high in tackiness, conducive to full spreading on the surfaces of the reinforced fibers and infiltrating the reinforced fibers. On the other hand, the reinforced fiber thermoplastic prepreg provided by the present invention cannot be quickly hardened, and can be kept in a wetting condition for a long time, and has good bendability. The two aspects work together to make the reinforced fiber thermoplastic prepreg provided by the present invention easy to transfer and adjust the shape, so that the reinforced fiber thermoplastic prepreg can be flexibly adapted to various special-shaped molds and base materials. When the reinforced fiber thermoplastic prepreg is heated, the bisphenol glycidyl ether type epoxy resin component and the dihydric phenol compound component in the composite resin system can undergo a polymerization reaction under the catalysis of the catalyst component. The mechanism of the polymerization reaction is as follows: under the catalysis of the catalyst, the epoxy group of the bisphenol glycidyl ether type epoxy resin is opened and is polymerized with the dihydric phenol compound. Therefore, a product which can be obtained comprises thermoplastic resin with a molecular structure containing a chain segment as shown in a general formula, the general formula I is

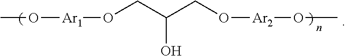

The weight average molecular weight of the thermoplastic resin can reach 40,000 to 60,000. The thermoplastic resin can jointly build a composite interface, with high interface strength, with the reinforced fibers.

Preferably, the reinforced fibers comprise at least one of carbon fibers, glass fibers, aramid fibers, Kevlar fiber, basalt fiber and nylon fiber.

Preferably, in the composite resin system, epoxy groups contained in the bisphenol glycidyl ether type epoxy resin:phenolic hydroxyl groups contained in the dihydric phenol compound is 0.98-1.03:1 calculated by molar ratio. When the ratio of the bisphenol glycidyl ether type epoxy resin and the dihydric phenol compound in the composite resin system meets the aforementioned relationship, on the one hand, the infiltration effect of the composite resin system on the reinforced fibers can be improved, and on the other hand, the yield of advantageous thermoplastic resins is improved, and the fact that the sports equipment body formed by forming of the reinforced fiber thermoplastic prepreg has better mechanical properties is reflected.

Preferably, the bisphenol glycidyl ether type epoxy resin comprises at least one of bisphenol A diglycidyl ether epoxy resin, bisphenol F diglycidyl ether epoxy resin, and bisphenol S diglycidyl ether epoxy resin.

Preferably, the dihydric phenol compound comprises at least one of a bisphenol compound, a fused polycyclic dihydroxy compound, and a phenol compound with allyl groups.

Preferably, the dihydric phenol compound comprises at least one of bisphenol A, bisphenol F, bisphenol S, dioxynaphthalene, diallyl resorcinol, diallyl bisphenol A, and triallyl dihydroxybiphenyl.

Preferably, the catalyst comprises an organic phosphine catalyst and a quaternary ammonium catalyst, wherein the organic phosphine catalyst comprises triphenylphosphine; the quaternary ammonium catalyst comprises tetrabutylammonium bromide; the amount of catalyst is met; the molar ratio of the triphenylphosphine to the tetrabutylammonium bromide is 1-3:1. The triphenylphosphine and the tetrabutylammonium bromide are matched with each other to form a composite catalyst. Under the catalysis of the composite catalyst, the adhesion of a produced thermoplastic resin product to a reinforced fiber material can be kept at a high level for a long time, which is conducive to the long-term stable compounding of the thermoplastic resins and the reinforced fiber material.

According to a second aspect of the present invention, application of the reinforced fiber thermoplastic prepreg in the manufacture of sports equipment and/or gas cylinders is provided. Sports equipment comprises but is not limited to bicycles, electric mopeds, surfboards, paddles and water bicycles, etc. Gas cylinders comprise but are not limited to industrial gas cylinders which comprise but are not limited to oxygen cylinders and hydrogen cylinders.

According to a third aspect of the present invention, a sports equipment body is provided. The sports equipment body is formed by compounding reinforced fibers and thermoplastic resin; the thermoplastic resin is formed by polymerizing bisphenol glycidyl ether type epoxy resin and a dihydric phenol compound; the molecular structure of the thermoplastic resin comprises a chain segment as shown in a general formula I; the general formula I is

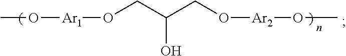

in the general formula I, Ar₁ and Ar₂ are independently selected from aromatic groups containing benzene rings, n is the polymerization degree of the chain segment as shown in general formula I; the weight average molecular weight of the thermoplastic resin is greater than or equal to 40,000.

Preferably, the glass transition temperature of the thermoplastic resin is 90 to 130 DEG C.

Preferably, the thermoplastic resin: the reinforced fibers is equal to 35-45:55-65 calculated by mass ratio.

According to a fourth aspect of the present invention, a forming method of the sports equipment body is provided. The method comprises the following operations: step 1, preparing a component A and a component B respectively, wherein the component A is formed by mixing bisphenol glycidyl ether type epoxy resin and a dihydric phenol compound; the component B comprises a catalyst; the catalyst comprises at least one of a quaternary ammonium catalyst and an organic phosphine catalyst; step 2, mixing the component A and the component B to obtain an impregnated mixture; step 3, dipping the reinforced fibers into the impregnated mixture to obtain a reinforced fiber thermoplastic prepreg; step 4, preparing a preform through the reinforced fiber thermoplastic prepreg; step 5, ensuring that the bisphenol glycidyl ether type epoxy resin and the dihydric phenol compound are polymerized under the catalysis of the catalyst, so that the thermoplastic resin is produced on the surfaces of the reinforced fibers through in situ polymerization, and the preform is converted into the sports equipment body.

Preferably, the component B is a mixed solution formed by dissolving the catalyst in a polar solution, or the component B is a resin mixed material formed by melting and mixing the catalyst and the bisphenol glycidyl ether type epoxy resin.

Preferably, the component B is a resin mixed material formed by melting and mixing the catalyst and the bisphenol glycidyl ether type epoxy resin, then the step 3 is: dipping the reinforced fibers into the resin mixed material to obtain a reinforced fiber thermoplastic prepreg.

Preferably, the tackiness of the resin mixed material at 40 DEG C. to 100 DEG C. is 30,000 to 100,000 cp.

Preferably, the component B is a mixed solution formed by dissolving the catalyst in a polar solution, and a mixed solution formed by mixing the component A and the component B is impregnated liquid. The step 3 is: dipping the reinforced fibers into the impregnated liquid to obtain a prepreg semifinished product, and then volatilizing a polar solvent contained in the prepreg semifinished product to obtain a reinforced fiber thermoplastic prepreg.

The step 3 is specifically: volatilizing the polar solvent contained in the prepreg semifinished product to obtain a reinforced fiber thermoplastic prepreg, then cutting required specifications and sizes on the reinforced fiber thermoplastic prepreg, manually laminating the prepreg into a sports equipment perform by laminating personnel according to researched and designed lamination, finally transferring the preform to a forming mold, closing the mold after sorting, and then pushing a forming mold to a forming table.

Preferably, the tackiness of the impregnated liquid is 80-120 cp. Based on the component compositions of presoak, further controlling the tackiness of the presoak within the aforementioned range is conducive to further improving the infiltration effect of the presoak on the reinforced fibers.

Preferably, the polar solvent comprises a ketones solvent. In polar solvents available for selection, the ketones solvents are less toxic and easy to volatilize. Components taking ketones solvents as a composite resin system not only is beneficial to the penetration of the composite resin system into reinforced fibers, but also can improve the forming safety and processing efficiency of the reinforced fiber thermoplastic prepreg.

Optionally, the polar solvent comprises at least one of methyl ethyl ketone, acetone and butanone.

Optionally, the polar solvent is methyl ethyl ketone.

In the aforementioned step 5, the conditions of the polymerization reaction are high temperature and high pressure.

Preferably, the process of the aforementioned step 5 comprises: S1, heating the preform to a first temperature at a heating rate of 3 to 5 DEG C./min; during the heating process, applying pressure to the preform and ensuring that the pressure is increased from a first pressure to a second pressure step by step, wherein, the first temperature is 100-130 DEG C., the first pressure is 30-60 psi, and the second pressure is 120-180 psi; S2, ensuring that the pressure applied to the preform is suddenly reduced to a third pressure when the preform reaches the first temperature, and maintaining temperature and pressure for 5-20 minutes at the first temperature and the third pressure, wherein the third pressure is 30-75 psi; S3, then heating the preform from the first temperature to a second temperature at a heating rate of 1 to 4 DEG C./min; during the heating process, ensuring that the pressure applied to the preform is increased to fourth pressure from the third pressure step by step; maintaining temperature and pressure for 50 to 120 minutes at the second temperature and the fourth pressure, to obtain a semifinished product, wherein the second temperature is 140 to 180 DEG C., and the fourth pressure is 180˜240 psi; S4, then cooling the semifinished product at a cooling rate of 3-5 DEG C./min; during the cooling process, keeping applying the fourth pressure to the semifinished product; opening a mold when the temperature drops to 30-70 DEG C., to obtain a finished product.

By adopting specific temperature and pressure control in the step 5 during the forming process, the method is conductive to further improvement of the structural stability of the blank (reinforced fibers and thermoplastic resin are not easily peeled off) and the mechanical properties of the blank.

### DETAILED DESCRIPTION OF EMBODIMENTS

To enable a person skilled in the art to better understand the scheme of the present invention, the technical scheme in the embodiments of the present invention will be clearly and completely described below, and it is clear that the embodiments described are a part of the embodiments of the present invention, and not all of them. In the following embodiments, forming equipment used forming the special-shaped blank of sports equipment is composite workpiece forming equipment described in a prior invention patent application text with a publication number CN112721078A by Dongguan Ten-Tech Composite Co., Ltd.

### Embodiment 1

### 1. Preparation of Reinforced Fiber Thermoplastic Prepreg

In the embodiment, a composite resin system and reinforced fibers are used for preparing the reinforced fiber thermoplastic prepreg. The composite resin system comprises reactive monomers and catalysts. Specifically, the reactive monomers comprise bisphenol glycidyl ether type epoxy resin and a dihydric phenol compound. In the embodiment, the types of the reactive monomers and catalysts included in the composite resin system are used as variables to set different treatment groups and control groups. The composition of the composite resin system corresponding to each group is as shown in Table 1. “Mw” in Table 1 indicates the weight average molecular weight of a corresponding material.

TABLE 1
Types and proportions of reactive monomers used by each treatment
group in the embodiment to prepare thermoplastic resin.

Bisphenol monomer and corresponding
dosage thereof

| | Bisphenol glycidyl ether | Dihydric phenol |
|---|---|---|
| Group | type epoxy resin | compound |
| Treatment | Bisphenol A diglycidyl ether | Bisphenol A |
| group 1A | epoxy resin (Mw = 380) | |
| Treatment | Bisphenol A diglycidyl ether | Bisphenol A |
| group 2A | epoxy resin (Mw = 650) | |
| Treatment | Bisphenol F diglycidyl ether | Bisphenol F |
| group 3A | epoxy resin (Mw = 350) | |
| Control | Bisphenol A diglycidyl ether | Bisphenol A |
| group 1 | epoxy resin (Mw = 1230) | |
| Control | Bisphenol F diglycidyl ether | Bisphenol F |
| group 2 | epoxy resin (Mw = 1100) | |

Table 1 indicates that both the treatment groups and the control groups complete the preparation of the reinforced fiber thermoplastic prepreg in the following manner:

### S1. Preparation of Composite Resin System

### S1.1 Preparation of Component A

Each treatment group corresponds to Table 1; weigh the bisphenol glycidyl ether type epoxy resin and the dihydric phenol compound used in each treatment group according to the amount; the amount of the bisphenol glycidyl ether type epoxy resin is 100 g, and the amount of the dihydric phenol compound is fixed according to epoxy groups contained in the bisphenol glycidyl ether type epoxy resin:phenolic hydroxyl groups contained in the dihydric phenol compound being equal to 1:1; heat the used bisphenol glycidyl ether type epoxy resin to about 120 DEG C.; then feed the dihydric phenol compound into the bisphenol glycidyl ether type epoxy resin; stir thoroughly until the bisphenol glycidyl ether type epoxy resin and the dihydric phenol compound are evenly dissolved into each other, thereby obtaining a component A; lowering the temperature of the component A to room temperature for standby application.

### S1.2 Preparation of Component B:

Triphenylphosphine and tetrabutylammonium bromide are used as catalysts; the mass of triphenylphosphine used is 1% of the total mass of the component A; the tetrabutylammonium bromide is taken according to the mass ratio of the triphenylphosphine to the tetrabutylammonium bromide being 2:1; use methyl ethyl ketone (MEK) as a polar solvent; weigh 40 g of MEK; then feed the triphenylphosphine and the tetrabutylammonium bromide into MEK to ensure that the aforementioned two catalysts are dissolved and fully dispersed in MEK until a uniform solution is formed, to obtain a component B for standby application. All treatment groups set in the embodiment are used for preparing the component B in the aforementioned manner.

### S1.3 Mixing

Mix the component A and the component B; stir the mixed slurry at first a low speed and then a high speed until the slurry is evenly mixed to obtain presoak containing a composite resin system; the tackiness of the presoak is 80-120 cp.

### S2. Preparation of Reinforced Fiber Thermoplastic Prepreg

Feed the aforementioned presoak into an impregnation tank; pull the reinforced fibers (the reinforced fibers used in each treatment group in the embodiment are carbon fibers, and the manufacturer and product name are Toray-T700) through a traction device, to obtain a prepreg semifinished product; then put the prepreg semifinished product in an internal and external circulation drying room to perform natural drying to fully volatilize the MEK, thus obtaining the reinforced fiber thermoplastic prepreg; during the aforementioned impregnation process, control the impregnation amount of the composite resin system to reach 40 wt % of the reinforced fiber thermoplastic prepreg by adjusting the tension and roller position of the traction device; control the unit area weight of the reinforced fibers in the reinforced fiber thermoplastic prepreg to reach 170 g/m2 by adjusting the drum rotation speed of the traction device.

### 2. Performance Testing of Reinforced Fiber Thermoplastic Prepreg

### (1) Testing Objects:

The reinforced fiber thermoplastic prepregs prepared in each treatment group and control group of the example are sampled for tackiness and bending testing.

### (2) Testing Items and Testing Methods

Tackiness (tacky, drop) testing of reinforced fiber thermoplastic prepreg: in the conditions of 25 DEG C.±2 DEG C., and 50%±2% RH, two pieces of prepregs provided by the same treatment group or control group are compounded face-to-face, and slightly press the prepregs with a roller to make the prepregs are laminated together. Judge the tackiness of the bonding state of the resulting laminate. Specific rating indicators and representative symbols are as follows:
∘: The prepreg is not easy to peel
x: The prepreg is easy to peel
▴: The tackiness is between the two, and the prepreg can be peeled.

Bendability testing of the reinforced fiber thermoplastic prepreg: in the conditions of 25 DEG C.±2 DEG C., and 50%±2% RH, the reinforced fiber thermoplastic prepreg is laminated on the surfaces of special-shaped substrates with the same shape. Judge the bendability by observing the bending and fracture conditions of the reinforced fiber thermoplastic prepreg. Specific rating indicators and representative symbols are as follows:

∘: the prepreg is easy to bend, and when the prepreg is laminated on the surfaces of special-shaped substrates, the fibers cannot be fractured.

x: the prepreg is difficult to bend and thick, and when the prepreg is laminated on the surfaces of special-shaped substrates, the fibers are fractured.

▴: compared with “o”, the prepreg is a little harder to bend, but when the prepreg is laminated on the surfaces of special-shaped substrates, the fibers cannot be fractured.

### (3) Test Results

The test results are shown in Table 2. In the groups tested, the resin component used to prepare the presoak comprises the bisphenol glycidyl ether type epoxy resin and the dihydric phenol compound. The resin component does not have high reactivity in normal temperature conditions. Therefore, the presoak prepared with the resin component can maintain a stable component composition in the normal temperature operating condition. The weight average molecular weight of the bisphenol glycidyl ether type epoxy resin used in the treatment group 1A, the treatment group 2A, and the treatment group 3A of the embodiment 1 falls within the range of 300 to 1000. Therefore, during the process of preparing presoak impregnated reinforced fibers through the aforementioned treatment groups, the tackiness of the prepreg can be maintained within a moderate range, which can not only fully infiltrate the reinforced fibers, but also be spread evenly on the surfaces of the reinforced fibers. After the solvent in the presoak is evaporated, the composite resin system remained in the prepreg can maintain appropriate tackiness, so that the prepreg can not only be firmly adhered to the surfaces of the reinforced fibers to ensure that the prepreg has excellent tackiness, but also enable the reinforced fiber thermoplastic prepreg to maintain good bendability, thus making the testing objects provided in the treatment group 1A, the treatment group 2A and the treatment group 3A of embodiment 1 be easy in transferring and shape adjustment and have excellent forming operability. However, the weight average molecular weight of the bisphenol glycidyl ether type epoxy resin used in the preparation of the composite resin system in the control group 1 and the control group 2 of the embodiment 1 is relatively high, as a result, the impregnation effect of the presoak on the reinforced fibers is significantly worse than that of presoak from other treatment groups, and the tackiness of the composite resin system and the distribution uniformity on the surfaces of the reinforced fibers is also significantly worse, so that the tackiness of the corresponding reinforced fiber thermoplastic prepreg is reduced.

TABLE 2
Performance test results of reinforced fiber
thermoplastic prepreg of embodiment 1

| | Tackiness of | Bendability of |
|---|---|---|
| Reinforced fiber | reinforced fiber | reinforced fiber |
| thermoplastic | thermoplastic | thermoplastic |
| prepreg group | prepreg | prepreg |
| Treatment group 1A | ∘ | ∘ |
| of embodiment 1 | | |
| Treatment group 2A | ∘ | ∘ |
| of embodiment 1 | | |
| Treatment group 3A | ∘ | ∘ |
| of embodiment 1 | | |
| Control group 1 of | x | ▴ |
| embodiment 1 | | |
| Control group 2 of | x | ▴ |
| embodiment 1 | | |

### 3. Preparation of Sports Equipment Special-Shaped Blank

Reinforced fiber thermoplastic prepregs prepared in each treatment group and control group in the embodiment are transferred to plastic dies with the same shapes as preforms. The following operations are performed on the preforms to be formed in sports equipment special-shaped blanks:
S1. Heat the preform to a first temperature at a heating rate of 5 DEG C./min; during the heating process, apply pressure to the preform and ensure that the pressure is increased from a first pressure to a second pressure step by step, wherein, the first temperature is 120 DEG C., the first pressure is 45 psi, and the second pressure is 150 psi;
S2. Ensure that the pressure applied to the preform is suddenly reduced to a third pressure when the preform reaches the first temperature, and maintain temperature and pressure for 10 minutes at the first temperature and the third pressure, wherein the third pressure is 45 psi;
S3. Then heat the preform from the first temperature to a second temperature at a heating rate of 3 DEG C./min; during the heating process, ensure that the pressure applied to the preform is increased to fourth pressure from the third pressure step by step; maintain temperature and pressure for 90 minutes at the second temperature and the fourth pressure, to obtain a semifinished product, wherein the second temperature is 150 DEG C., and the fourth pressure is 225 psi;
S4. Then cool the semifinished product at a cooling rate of 5 DEG C./min; during the cooling process, keep applying the fourth pressure to the semifinished product; open a mold when the temperature drops to 40 DEG C., to obtain a finished product.

The finished product of the sports equipment special-shaped blank prepared according to the aforementioned operations comprises reinforced fibers and thermoplastic resin, wherein the weight average molecular weight of the thermoplastic resin included is 40,000-60,000, and the mass percent of the thermoplastic resin in the sports equipment special-shaped blank is about 40%.

### 4. Performance Testing of Sports Equipment Special-Shaped Blank

### (1) Testing Objects

The sports equipment special-shaped blanks produced by each treatment group and control group of the embodiment are used as testing objects.

### (2) Testing Items and Testing Methods Thereof

Bending strength: ASTM D7264-15 (three point bending test of composite).

Interlaminar shear strength: ASTM D2344-16 (interlaminar shear test of composite).

Impact performance: ISO 179-1.

### (3) Test Results

The test results of the embodiment are shown in Table 3. During the process of forming the sports equipment special-shaped blank involved in the embodiment 1, by heating the reinforced fiber thermoplastic prepreg, the bisphenol glycidyl ether type epoxy resin and dihydric phenol compound components included can be subject to polymerization under the catalysis of the catalyst; the molecular structure produced comprises a chain segment as shown in a general formula I; the forming of the sports equipment special-shaped blank is completed after the thermoplastic resin is cured. The general formula I is

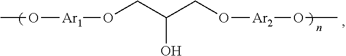

wherein Ar1 and Ar2 indicate aromatic groups containing benzene rings, and n is the polymerization degree of the chain segment as shown in the general formula I. It can be seen from the test results as shown in Table 3 that in the test objects, the mechanical properties of the sports equipment special-shaped blanks provided by the treatment group 1A, the treatment group 2A and the treatment group 3A of embodiment 1 are obviously better. The weight average molecular weight of the thermoplastic resin obtained from the treatment groups reaches the range from 40,000-60,000. The thermoplastic resin can build a composite interface with high interface strength with the reinforced fibers. The performances in all aspects such as bending strength, interlaminar shear strength and impact performance of the sports equipment special-shaped blanks produced by the control group 1 and the control group 2 of the embodiment 1 are poor.

TABLE 3
Performance test results of the sports equipment
special-shaped blank of embodiment 1

| Sports equipment | Bending | Interlaminar | Impact |
|---|---|---|---|
| special-shaped | strength/ | shear | performance/ |
| blank group | MPa | strength/MPa | (KJ/m²) |
| Treatment group 1A | 1400 | 80 | 240 |
| of embodiment 1 | | | |
| Treatment group 2A | 1300 | 75 | 220 |
| of embodiment 1 | | | |
| Treatment group 3A | 1240 | 76 | 232 |
| of embodiment 1 | | | |
| Control group 1 of | 1130 | 68 | 183 |
| embodiment 1 | | | |
| Control group 2 of | 1140 | 65 | 180 |
| embodiment 1 | | | |

### Embodiment 2

### 1. Preparation of Reinforced Fiber Thermoplastic Prepreg

In the embodiment, the treatment group 1A of the embodiment 1 is used as a reference, and a composite resin system and reinforcing fibers are used for preparing a reinforced fiber thermoplastic prepreg. Referring to the treatment group 1A of the embodiment 1, in the embodiment, the ratio of bisphenol glycidyl ether type epoxy resin to a dihydric phenol compound is used as a variable in each treatment group, different treatment groups are set, which are respectively numbered as treatment group 1B and treatment group 2B. The specific variable settings are as shown in Table 4. Except for the variables as shown in Table 4, other materials and operations used for preparing the reinforced fiber thermoplastic prepreg in the treatment group 1B and the treatment group 2B in the embodiment are strictly consistent with the treatment group 1A in the embodiment 1.

TABLE 4
Adopting of reactive monomers for preparing thermoplastic
resin in each treatment group in the embodiment

| Reinforced fiber | |
|---|---|
| thermoplastic | |
| prepreg group | Adopting of reactive monomers |
| Treatment group 1A | Epoxy groups contained in the bisphenol |
| of embodiment 1 | glycidyl ether type epoxy resin: phenolic |
| | hydroxyl groups contained in the dihydric |
| | phenol compound is 1:1 |
| Treatment group 1B | Epoxy groups contained in the bisphenol |
| of embodiment 2 | glycidyl ether type epoxy resin: phenolic |
| | hydroxyl groups contained in the dihydric |
| | phenol compound is 0.5:1 |
| Treatment group 2B | Epoxy groups contained in the bisphenol |
| of embodiment 2 | glycidyl ether type epoxy resin: phenolic |
| | hydroxyl groups contained in the dihydric |
| | phenol compound is 2:1 |

### 2. Performance Testing of Reinforced Fiber Thermoplastic Prepreg

### (1) Testing Objects:

Samples of reinforced fiber thermoplastic prepregs produced in the treatment group 1A of embodiment 1 and each treatment group in the embodiment are subjected to tackiness testing and bending testing.

### (2) Testing Items and Testing Methods

Tackiness testing of reinforced fiber thermoplastic prepreg: the same to the tackiness detection method and rating indicators of the reinforced fiber thermoplastic prepreg involved in the embodiment 1.

Bending testing of reinforced fiber thermoplastic prepreg: the same to the bending detection method and rating indicators of the reinforced fiber thermoplastic prepreg involved in the embodiment 1.

### (3) Test Results

The test results are as shown in Table 5. Resin component compositions used in the treatment group 1A of the embodiment 1, the treatment group 1B of the embodiment 2, and the treatment group 2B of the embodiment 2 are different, so that the impregnation effect of the presoak on the reinforced fibers is also different. The amount of the bisphenol glycidyl ether type epoxy resin and the dihydric phenol compound in the treatment group 1A of embodiment 1 meet the condition that epoxy groups contained in the bisphenol glycidyl ether type epoxy resin:phenolic hydroxyl groups contained in the dihydric phenol compound is 1:1, the impregnation effect of the presoak on the reinforced fibers is good, and the reinforced fiber thermoplastic prepreg made of the presoak has excellent tackiness and bendability.

TABLE 5
Performance test results of reinforced fiber
thermoplastic prepreg of embodiment 2

| Reinforced fiber | Tackiness of | Bendability of |
|---|---|---|
| thermoplastic | reinforced fiber | reinforced fiber |
| prepreg group | thermoplastic prepreg | thermoplastic prepreg |
| Treatment group 1A | ∘ | ∘ |
| of embodiment 1 | | |
| Treatment group 1B | ∘ | ▴ |
| of embodiment 2 | | |
| Treatment group 2B | ▴ | ∘ |
| of embodiment 2 | | |

### 3. Preparation of Sports Equipment Special-Shaped Blank

The reinforced fiber thermoplastic prepregs prepared in each treatment group and control group of the embodiment are used for preparing sports equipment special-shaped blanks according to the method for preparing sports equipment special-shaped blank in the embodiment 1, except that the reinforced fiber thermoplastic prepregs used are different, all operations during the preparation of sports equipment special-shaped blank of the embodiment are strictly consistent with that of the embodiment 1.

### 4. Performance Testing of Sports Equipment Special-Shaped Blank

### (1) Testing Objects

Sports equipment special-shaped blanks produced by the treatment group 1A of the embodiment 1 and each treatment group of the embodiment are used as test objects.

### (2) Testing Items and Testing Methods Thereof

Bending strength: ASTM D7264-15 (three point bending test of composite).

Interlaminar shear strength: ASTM D2344-16 (interlaminar shear test of composite).

Impact performance: ISO 179-1.

### (3) Test Results

The test results of the test example are shown in Table 6. It can be seen that in the test objects, the sports equipment special-shaped blank produced by the treatment group 1A of the embodiment 1 has the best mechanical properties. On the one hand, the impregnation effect of the presoak prepared by the treatment group 1A of the embodiment 1 on the reinforced substrate is the best, and the thermoplastic resin can be evenly and firmly adhered to the surfaces of the reinforced fibers. On the other hand, the resin component contained in the reinforced fiber thermoplastic prepreg meets the specific ratio. The ratio is conducive to improving the yield of resins with mechanical properties, is conductive to improving the yield of resin with mechanical property advantages, and ensure that the mechanical property of the sports equipment special-shaped blank shows advantages in aspects of bending strength, interlaminar shear strength and impact performance.

TABLE 6
Performance test results of sports equipment
special-shaped blank of embodiment 2

| Sports equipment | Bending | Interlaminar | Impact |
|---|---|---|---|
| special-shaped | strength/ | shear strength/ | performance/ |
| blank group | MPa | MPa | (KJ/m²) |
| Treatment group 1A | 1400 | 80 | 240 |
| of embodiment 1 | | | |
| Treatment group 1B | 1370 | 76 | 230 |
| of embodiment 2 | | | |
| Treatment group 2B | 1350 | 72 | 210 |
| of embodiment 2 | | | |

### Embodiment 3

### 1. Preparation of Reinforced Fiber Thermoplastic Prepreg

In the embodiment, the treatment group 1A of the embodiment 1 is used as a reference, and a composite resin system and reinforcing fibers are used for preparing a reinforced fiber thermoplastic prepreg. Referring to the treatment group 1A of the embodiment 1, in the embodiment, the catalyst composition used for preparing thermoplastic resin is used as a variable to set different treatment groups. According to the different catalysts used, a treatment group 1C, a treatment group 2C, a treatment group 3C and a treatment group 4C are set. The specific composition of the catalyst used in each treatment group is as shown in Table 7. The total mass of the catalyst used in each treatment group is the same. During the process of preparing thermoplastic resin in each treatment group of the example, except for the variables as shown in Table 7, other materials and operations used for preparing the reinforced fiber thermoplastic prepreg are strictly consistent with the treatment group 1A in the embodiment 1.

TABLE 7
Catalyst composition used by each treatment group
in the example for preparing thermoplastic resin

| Group | Catalyst composition |
|---|---|
| Treatment group 1A | Triphenylphosphine:tetrabutylammonium |
| of embodiment 1 | bromide = 2:1 (mass ratio) |
| Treatment group 1C | Triphenylphosphine:tetrabutylammonium |
| of embodiment 3 | bromide = 4:1 (mass ratio) |
| Treatment group 2C | Triphenylphosphine:tetrabutylammonium |
| of embodiment 3 | bromide = 0.5:1 (mass ratio) |
| Treatment group 3C | Monocomponent:triphenylphosphine |
| of embodiment 3 | |
| Treatment group 4C | Monocomponent:tetrabutylammonium bromide |
| of embodiment 3 | |

### 2. Performance Testing of Reinforced Fiber Thermoplastic Prepreg

### (1) Testing Objects:

Samples of reinforced fiber thermoplastic prepregs produced in the treatment group 1A of embodiment 1 and each treatment group in the embodiment are subjected to tackiness testing and bending testing.

### (2) Testing Items and Testing Methods

Tackiness testing of reinforced fiber thermoplastic prepreg: the same to the tackiness detection method and rating indicators of the reinforced fiber thermoplastic prepreg involved in the embodiment 1.

Bending testing of reinforced fiber thermoplastic prepreg: the same to the bending detection method and rating indicators of the reinforced fiber thermoplastic prepreg involved in the embodiment 1.

### (3) Test Results

The test results are as shown in Table 8. The difference in material composition between the reinforced fiber thermoplastic prepregs as the test objects of the test example lies in difference of the compositions of the catalysts contained in the composite resin system. It can be seen from the test results as shown in Table 8 that the tackiness and bendability of the reinforced fiber thermoplastic prepregs made of different catalysts with different components are also different.

TABLE 8
Performance test results of reinforced fiber
thermoplastic prepreg of embodiment 3

| Reinforced fiber | Tackiness of | Bendability of |
|---|---|---|
| thermoplastic | reinforced fiber | reinforced fiber |
| prepreg group | thermoplastic prepreg | thermoplastic prepreg |
| Treatment group 1A | ∘ | ∘ |
| of embodiment 1 | | |
| Treatment group 1C | ∘ | ∘ |
| of embodiment 3 | | |
| Treatment group 2C | ▴ | ▴ |
| of embodiment 3 | | |
| Treatment group 3C | ∘ | ∘ |
| of embodiment 3 | | |
| Treatment group 4C | ▴ | ▴ |
| of embodiment 3 | | |

### 3. Preparation of Sports Equipment Special-Shaped Blank

The reinforced fiber thermoplastic prepregs prepared in each treatment group and control group of the embodiment are used for preparing sports equipment special-shaped blanks according to the method for preparing sports equipment special-shaped blank in the embodiment 1, except that the reinforced fiber thermoplastic prepregs used are different, all operations during the preparation of sports equipment special-shaped blank of the embodiment are strictly consistent with that of the embodiment 1.

### 4. Performance Testing of Sports Equipment Special-Shaped Blank

### (1) Testing Objects

Sports equipment special-shaped blanks produced by the treatment group 1A of the embodiment 1 and each treatment group of the embodiment are used as test objects.

### (2) Testing Items and Testing Methods Thereof

Bending strength: ASTM D7264-15 (three point bending test of composite).

Interlaminar shear strength: ASTM D2344-16 (interlaminar shear test of composite).

Impact performance: ISO 179-1.

### (3) Test Results

The test results of the test example are as shown in Table 9. The test results show that the tested composite fiber thermoplastic prepregs can all be produced to formed sports equipment special-shaped blanks, which shows that triphenylphosphine and tetrabutylammonium bromide used as single-component catalysts respectively or used as a combined catalyst can effectively catalyze the polymerization of the resin component in the composite fiber thermoplastic prepregs and convert the resin into thermoplastic resin. However, compared to the treatment group 3C of the embodiment 3 using triphenylphosphine as a single-component catalyst and the treatment group 4C of the embodiment 3 using tetrabutylammonium bromide as a single-component catalyst, the bending strength, the interlaminar shear strength and the impact performance of the sports equipment special-shaped blanks produced by the treatment group 1A of the embodiment 1, the treatment group 1C of the embodiment 3 and the treatment group 2C of the embodiment 3 using triphenylphosphine and tetrabutylammonium bromide as a combined catalyst are improved. Therefore, it indicates that in the forming process of the sports equipment special-shaped blank, the use of triphenylphosphine and tetrabutylammonium bromide to jointly exert combined catalytic effect on the resin system is conducive to further improving the comprehensive mechanical properties of the sports equipment special-shaped blank. In addition, it can be seen from the test results as shown in Table 9 that when the amount ratio of triphenylphosphine to tetrabutylammonium bromide reaches triphenylphosphine:tetrabutylammonium bromide being 2:1, the comprehensive mechanical properties of the resulting sports equipment special-shaped blank are the best.

TABLE 9
Performance test results of sports equipment
special-shaped blank of embodiment 3

| Sports equipment | Bending | Interlaminar | Impact |
|---|---|---|---|
| special-shaped | strength/ | shear strength/ | performance/ |
| blank group | MPa | MPa | (KJ/m²) |
| Treatment group 1A | 1400 | 80 | 240 |
| of embodiment 1 | | | |
| Treatment group 1C | 1380 | 76 | 230 |
| of embodiment 3 | | | |
| Treatment group 2C | 1360 | 72 | 210 |
| of embodiment 3 | | | |
| Treatment group 3C | 1250 | 80 | 260 |
| of embodiment 3 | | | |
| Treatment group 4C | 1320 | 70 | 210 |
| of embodiment 3 | | | |

### Embodiment 4

### 1. Preparation of Reinforced Fiber Thermoplastic Prepreg

Materials and specific methods for preparing the reinforced fiber thermoplastic prepreg in the embodiment are completely consistent with that of the treatment group 1A of the embodiment 1.

### 2. Preparation of Reinforced Fiber Thermoplastic Prepreg Special-Shaped Blank

The aforementioned reinforced fiber thermoplastic prepregs prepared in the embodiment are used for preparing reinforced fiber thermoplastic prepreg special-shaped blanks in different forming methods. According to the different forming methods, different treatment groups are set, which are numbered as a treatment group 1D, a treatment group 2D, a treatment group 3D and a treatment group 4D.

(1) The treatment group 1D completes the preparation of the sports equipment special-shaped blank in the following manner:
S1. Heat a preform to 150 DEG C. at a heating rate of 5 DEG C./min; during the heating process, apply pressure to the preform and ensure that the pressure is increased from a first pressure to a second pressure step by step, wherein, the first pressure is 45 psi, and the second pressure is 150 psi;
S2. Ensure that the pressure applied to the preform is suddenly reduced to a third pressure when the preform reaches 150 DEG C., and maintain temperature and pressure for 10 minutes at 150 DEG C. and the third pressure, wherein the third pressure is 45 psi;
S3. Ensure that the pressure applied to the preform is increased to a fourth pressure from the third pressure step by step; maintain temperature and pressure for 90 minutes at 150 DEG C. and the fourth pressure, to obtain a semifinished product, wherein the fourth pressure is 225 psi;
S4. Then cool the semifinished product at a cooling rate of 5 DEG C./min; during the cooling process, keep applying the fourth pressure to the semifinished product; open a mold when the temperature drops to 40 DEG C., to obtain a finished product.

(2) The treatment group 2D completes the preparation of the sports equipment special-shaped blank in the following manner:
S1. Heat a preform to a first temperature at a heating rate of 5 DEG C./min; during the heating process, apply pressure to the preform and ensure that the pressure is increased from 45 psi to 225 psi step by step, wherein, the first temperature is 120 DEG C.;
S2. Maintain temperature and pressure for 10 minutes at the first temperature and a pressure of 225 psi when the preform reaches the first temperature;
S3. Continuously keep applying a pressure of 225 psi to the preform; then heat the preform from the first temperature to a second temperature at a heating rate of 3 DEG C./min; maintain temperature and pressure for 90 minutes at the second temperature and a pressure of 225 psi, to obtain a semifinished product, wherein the second temperature is 150 DEG C.;
S4. Then cool the semifinished product at a cooling rate of 5 DEG C./min; during the cooling process, keep applying the fourth pressure to the semifinished product; open a mold when the temperature drops to 40 DEG C., to obtain a finished product.

(3) The treatment group 3D completes the preparation of the sports equipment special-shaped blank in the following manner:
S1. Heat a preform to a first temperature at a heating rate of 5 DEG C./min; during the heating process, apply pressure to the preform and ensure that the pressure is increased from 45 psi to 150 psi step by step, wherein, the first temperature is 120 DEG C.;
S2. Maintain temperature and pressure for 10 minutes at the first temperature and a pressure of 150 psi when the preform reaches the first temperature;
S3. Heat the preform from the first temperature to a second temperature at a heating rate of 3 DEG C./min; during the heating process, ensure that the pressure applied to the preform is increased from 150 psi to 225 psi step by step; maintain temperature and pressure for 90 minutes at the second temperature and a pressure of 225 psi, to obtain a semifinished product, wherein the second temperature is 150 DEG C.;
S4. Then cool the semifinished product at a cooling rate of 5 DEG C./min; during the cooling process, keep applying a pressure of 225 psi to the semifinished product; open a mold when the temperature drops to 40 DEG C., to obtain a finished product.

(4) The treatment group 4D completes the preparation of the sports equipment special-shaped blank in the following manner:
S1. Heat the preform to a first temperature at a heating rate of 5 DEG C./min; during the heating process, apply pressure to the preform and ensure that the pressure is increased from a first pressure to a second pressure step by step, wherein, the first temperature is 120 DEG C., the first pressure is 45 psi, and the second pressure is 150 psi;
S2. Ensure that the pressure applied to the preform is suddenly reduced to a third pressure when the preform reaches the first temperature, and maintain temperature and pressure for 10 minutes at the first temperature and the third pressure, wherein the third pressure is 45 psi;
S3. Then heat the preform from the first temperature to a second temperature at a heating rate of 3 DEG C./min; during the heating process, ensure that the pressure applied to the preform is increased to fourth pressure from the third pressure step by step; maintain temperature and pressure for 90 minutes at the second temperature and the fourth pressure, to obtain a semifinished product, wherein the second temperature is 150 DEG C., and the fourth pressure is 225 psi;
S4. Naturally cool the semifinished product; stop applying pressure to the semifinished product during the cooling process; open a mold when the temperature drops to 40 DEG C., to obtain a finished product.

### 3. Performance Testing of Sports Equipment Special-Shaped Blank

### (1) Testing Objects

Sports equipment special-shaped blanks produced by the treatment group 1A of the embodiment 1 and each treatment group of the embodiment are used as test objects.

### (2) Testing Items and Testing Methods Thereof

Bending strength: ASTM D7264-15 (three point bending test of composite).

Interlaminar shear strength: ASTM D2344-16 (interlaminar shear test of composite).

Impact performance: ISO 179-1.

### (3) Test Results

The test results of the test example are as shown in Table 10. As mentioned above, the presoak components used in the treatment group 1A of the embodiment 1 and the treatment group 1D, the treatment group 2D, the treatment group 3D and the treatment group 4D of the embodiment 4 are the same and the types of reinforced fibers are the same. The material compositions of the reinforced fiber thermoplastic prepregs produced by the treatment groups are also exactly the same. However, the specific processes for forming the sports equipment special-shaped blanks through the reinforced fiber thermoplastic prepregs are different. Taking the process of forming the sports equipment special-shaped blank through the treatment group 1A of the embodiment 1 as a reference and comparison: during the process of forming the sports equipment special-shaped blank through the treatment group 1D of the embodiment 4, a complete gradient temperature control process is not adopted, and the forming temperature is controlled at 150 DEG C. (equivalent to the “second temperature” during the process of preparation of the sports equipment special-shaped blank through the treatment group 1A of the embodiment 1) for a long time; during the process of forming the sports equipment special-shaped blank through the treatment group 2D of the embodiment 4, the pressure is controlled at 225 psi (equivalent to the “fourth pressure” during the process of preparation of the sports equipment special-shaped blank through the treatment group 1A of the embodiment 1) for a long time; the operation of a sudden change in pressure is cancelled by the treatment group 3D of the embodiment 4 in S2; the operations of temperature control and maintaining pressure during the cooling process S4 are cancelled by the treatment group 4D of the embodiment 4. It can be seen from the test results as shown in Table 10 that the mechanical properties of sports equipment special-shaped blanks prepared through different forming methods are different. In the tested sports equipment special-shaped blanks, the performances in all aspects such as bending strength, interlaminar shear strength and impact performance of the sports equipment special-shaped blanks produced by the treatment group 1A of the embodiment 1 present the advantages.

TABLE 10
Performance test results of sports equipment
special-shaped blank of embodiment 4

| Sports equipment | Bending | Interlaminar | Impact |
|---|---|---|---|
| special-shaped | strength/ | shear | performance/ |
| blank group | MPa | strength/MPa | (KJ/m²) |
| Treatment group 1A | 1400 | 80 | 240 |
| of embodiment 1 | | | |
| Treatment group 1D | 1250 | 75 | 190 |
| of embodiment 4 | | | |
| Treatment group 2D | 1350 | 78 | 220 |
| of embodiment 4 | | | |
| Treatment group 3D | 1180 | 70 | 210 |
| of embodiment 4 | | | |
| Treatment group 4D | 1230 | 72 | 205 |
| of embodiment 4 | | | |

The above embodiments are only used to illustrate the technical scheme of the present invention and do not limit the protection scope of the present invention. Although the present invention has been described in detail with reference to the aforementioned embodiments, those of ordinary skill in the art should understand that modifications or equivalent substitutions of the technical scheme of the present invention can be carried out. However, these modifications or equivalent substitutions are all within the protection scope of the present invention.

What is claimed is:

1. A reinforced fiber thermoplastic prepreg, characterized in that the reinforced fiber thermoplastic prepreg comprises reinforced fibers and a composite resin system, wherein the composite resin system comprises bisphenol glycidyl ether type epoxy resin, a dihydric phenol compound and a catalyst; the weight average molecular weight of the bisphenol glycidyl ether type epoxy resin is 300 to 1000; the catalyst comprises at least one of a quaternary ammonium catalyst and an organic phosphine catalyst.

2. A reinforced fiber thermoplastic prepreg according to claim 1, characterized in that in the composite resin system, epoxy groups contained in the bisphenol glycidyl ether type epoxy resin:phenolic hydroxyl groups contained in the dihydric phenol compound is 0.98-1.03:1 calculated by molar ratio.

3. A reinforced fiber thermoplastic prepreg according to claim 1, characterized in that in the catalyst comprises the organic phosphine catalyst and the quaternary ammonium catalyst, wherein the organic phosphine catalyst comprises triphenylphosphine; the quaternary ammonium catalyst comprises tetrabutylammonium bromide; the amount of the catalysts is met that the molar ratio of the triphenylphosphine to the tetrabutylammonium bromide is 1-3:1.

4. Application of the reinforced fiber thermoplastic prepreg according to any one of claim 1, claim 2 and claim 3 to production of sports equipment and/or gas cylinders.

5. A sports equipment body, characterized in that the blank is formed by compounding reinforced fibers and thermoplastic resin, wherein the thermoplastic resin is formed by polymerizing bisphenol glycidyl ether type epoxy resin and a dihydric phenol compound; the molecular structure of the thermoplastic resin comprises a chain segment as shown in a general formula I; the general formula I is 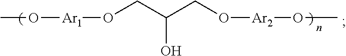
in the general formula I, Ar₁ and Ar₂ are independently selected from aromatic groups containing benzene rings, n is the polymerization degree of the chain segment as shown in general formula I; the weight average molecular weight of the thermoplastic resin is greater than or equal to 40,000.

6. A sports equipment body according to claim 5, characterized in that the glass transition temperature of the thermoplastic resin is 90 to 130 DEG C.

7. A sports equipment body according to claim 5, characterized in that the thermoplastic resin:the reinforced fibers is equal to 35-45:55-65 calculated by mass ratio.

8. A forming method of the sports equipment body, according to any one of claim 5, claim 6 and claim 7, characterized by comprising the following operations:
then preparing a preform through the reinforced fiber thermoplastic prepreg;
step 1: preparing a component A and a component B respectively, wherein the component A is formed by mixing bisphenol glycidyl ether type epoxy resin and a dihydric phenol compound; the component B comprises a catalyst; the catalyst comprises at least one of a quaternary ammonium catalyst and an organic phosphine catalyst;
step 2, mixing the component A and the component B to obtain an impregnated mixture;
step 3, dipping the reinforced fibers into the impregnated mixture to obtain a reinforced fiber thermoplastic prepreg;
step 4, preparing a preform through the reinforced fiber thermoplastic prepreg;
step 5, ensuring that the bisphenol glycidyl ether type epoxy resin and the dihydric phenol compound are polymerized under the catalysis of the catalyst in high temperature and high pressure conditions, so that the thermoplastic resin is produced on the surfaces of the reinforced fibers through in situ polymerization, and the preform is converted into the sports equipment body.

9. A forming method of the sports equipment body, according to claim 8, characterized in that the component B is a mixed solution formed by dissolving the catalyst in a polar solution, or the component B is a resin mixed material formed by melting and mixing the catalyst and the bisphenol glycidyl ether type epoxy resin.

10. A forming method of the sports equipment body, according to claim 9, characterized in that the polar solution comprises a ketones solvent.

11. A forming method of the sports equipment body, according to any one of claim 8, claim 9 and claim 10, characterized in that the process of the step 5 comprises:
S1, heating the preform to a first temperature at a heating rate of 3 to 5 DEG C./min; during the heating process, applying pressure to the preform and ensuring that the pressure is increased from a first pressure to a second pressure step by step, wherein, the first temperature is 100-130 DEG C., the first pressure is 30-60 psi, and the second pressure is 120-180 psi;
S2, ensuring that the pressure applied to the preform is suddenly reduced to a third pressure when the preform reaches the first temperature, and maintaining temperature and pressure for 5-20 minutes at the first temperature and the third pressure, wherein the third pressure is 30-75 psi;
S3, then heating the preform from the first temperature to a second temperature at a heating rate of 1 to 4 DEG C./min; during the heating process, ensuring that the pressure applied to the preform is increased to fourth pressure from the third pressure step by step; maintaining temperature and pressure for 50 to 120 minutes at the second temperature and the fourth pressure, to obtain a semifinished product, wherein the second temperature is 140 to 180 DEG C., and the fourth pressure is 180˜240 psi;
S4, then cooling the semifinished product at a cooling rate of 3-5 DEG C./min; during the cooling process, keeping applying the fourth pressure to the semifinished product; opening a mold when the temperature drops to 30-70 DEG C., to obtain a finished product.
